(19) United States
(12) Patent Application Publication
(10) Pub. No.: US 2010/0209073 A1
(43) Pub. Date: Aug. 19, 2010

(54) Interactive Entertainment System for Recording Performance

(76) Inventor: Dennis Fountaine, Sarasota, FL (US)

Correspondence Address: CARR & FERRELL LLP, 2200 GENG ROAD, PALO ALTO, CA, 94303, US

(21) Appl. No.: 12/562,962

(22) Filed: Sep. 18, 2009

Related U.S. Application Data
(60) Provisional application No. 61/192,642, filed on Sep. 18, 2008.
(60) Provisional application No. 61/192,542, filed on Sep. 18, 2008.
(60) Provisional application No. 61/192,674, filed on Sep. 18, 2008.

(51) Int. Cl. H04N 5/91

(52) U.S. Cl. 386/68; 386/E05.003

(57) ABSTRACT

An interactive entertainment system for recording performance is disclosed. After receiving a user selection of a video clip from a media clip library, a pre-engineered version of the selected video clip is sent to the user. The user submits a recording of a performance associated with the selected video clip. The received recording is composited with the selected video clip to generate a composite video clip in which the user performance appears in context of the selected video clip. The generated composited video clip may be viewed and shared or alternatively submitted in response to a casting call.

### CROSS-REFERENCE TO RELATED APPLICATIONS

The present application claims the priority benefit of U.S. provisional patent application No. 61/192,642 filed Sep. 18, 2008 and entitled “Interactive Entertainment System, U.S. provisional patent application No. 61/192,542 filed Sep. 18, 2008 and entitled “System and Method for Pre-Engineering Video Clips,” and U.S. provisional patent application 61/192,674 filed Sep. 18, 2008 and titled “System and Method for Social Casting Call,” the disclosures of the aforementioned applications being incorporated herein by reference.

### BACKGROUND OF THE INVENTION

1. Field of the Invention

The present invention generally relates to an interactive entertainment system. More specifically, the present invention concerns the generation of a composite video clip including a recording of a performance.

2. Description of Related Art

Presently, video clips can originate from movies, television shows, radio shows, music videos, cartoons, video games, advertisements, commercials, news shows, or other sources. In addition to full-length television programs and movies made freely available on-line by well-established television networks and media sources, Internet users can also access, view, upload, share, and/or critique millions of video clips, including amateur video clips made available on websites such as YouTube or iPlayer.

Video and audio are media that allow individuals to showcase their performances for various audiences. Such performances may include singing, dancing, acting, orating, debating, animation, etc. Showcasing one's performance is particularly important in the fields of musical, theatrical, and cinematic arts. Singers, dancers, and actors of all types need to be able to demonstrate their singing, dancing, or acting abilities in order to obtain employment in their chosen fields. Such a demonstration may occur in the context of an audition or audio-video recordings of a past performance.

In a general casting call, for example, a casting director or associate generally manages a process to select one or more actors or other entertainment performers to fulfill one or more roles in a live or recorded performance. The casting process is typically performed live and can be burdensome, time-consuming and stressful for all parties involved. Such live auditions may be restricted in terms of geography, timing, scheduling, etc. For example, an audition may be held in an inconvenient location, at an inconvenient time, and/or may not allow much time for a full performance. Further, an audition may lack the context of an actual performance (e.g., band, orchestra, costuming, lighting, sets, other performers).

While an audio-video recording may provide such context, some individuals may not have the resources or the opportunity to prepare such a recording or the opportunity. There is therefore, a need for an interactive entertainment system for recording performances.

### SUMMARY OF THE INVENTION

Present embodiments of the present invention allows for an interactive entertainment system that allows for generation of composite clips incorporating a recording of a performance. A library of media clips is available for viewing and selection by a user. Upon selecting a clip, the user is provided with a media clip that has been pre-engineered and processed for play on a user device. The user may play the media clip for purposes of study and preparation. When the user is ready, the user may provide a recording of a user performance. The user performance may track that of a performer in the clip (e.g., recite the same lines, sing the same song). A composite clip is then generated based on the recording of the user performance and the selected media clip. As such, the user performance appears in context of the selected media clip.

In one exemplary embodiment of the invention, a method for generating a composited video clip is disclosed. A machine-readable medium comprising executable instructions for implementing this method is also disclosed. Through this method, a media clip library comprising a plurality of video clips is stored in memory. After receiving a user selection of a video clip from the video clip library, a pre-engineered version of the video clip designated by the user is sent to the user. A user recording is received from the user, wherein the recording captures a user performance associated with the selected video clip. The received recording is then composited with the selected video clip to generate a composited video clip in which the user performance appears in context of the selected video clip. A composited video clip may be viewed and shared. In some embodiments, the composited video clip may be submitted in response to a casting call. A machine-readable medium comprising executable instructions for implementing this method is also disclosed.

An exemplary system for generating a composited video clip is also provided. In an exemplary system, a memory may be configured to maintain a media clip library comprising a plurality of video clips. The system may further include an interface for receiving a user selection of a video clip from the clip library, sending the user a pre-engineered version of the video clip designated by the user selection, and receiving a recording of the user wherein the recording captures a user performance associated with the selected video clip. The system may further include a processor capable of executing instructions stored in memory wherein execution of the instructions by the processor generates a composite video clip based on the received recording and the selected video clip. The composite video clip may display user performance in the context of the selected video clip.

### BRIEF DESCRIPTION OF FIGURES

FIG. 1 illustrates an exemplary environment in which embodiments of the present invention may be implemented.

FIG. 2 illustrates an exemplary server for generating a composite video clip.

FIG. 3 is a flowchart illustrating an exemplary method for generating a composite video clip.

FIG. 4 is a screenshot of an exemplary interface for browsing a clip library.

FIG. 5 is a screenshot of an exemplary template used to align a user's image.

FIG. 6 is a screenshot of an exemplary adjustment screen.

FIG. 7 is a screenshot of an exemplary interface for exporting the composite video clip to other systems.

FIG. 8A is a screenshot of an exemplary pre-engineered video clip.

FIG. 8B is a screenshot of a pre-engineered video clip as it may be used in an exemplary implementation of an interactive entertainment system for recording performance.

### DETAILED DESCRIPTION

Embodiments of the present invention provide systems and methods for providing an interactive entertainment system. In exemplary embodiments, a user may place themselves and/or others into a video clip. The video clip may be any short clip of video that is edited, clipped or spliced from a longer program or work. The video clip may comprise, for example, a scene from a movie, television show, music video, cartoon, video game, advertisement, commercial, or promotion. Other types of video clips, including media clips, may be also used. A composite video clip may be generated whereby the user becomes the “actor” in the video clip.

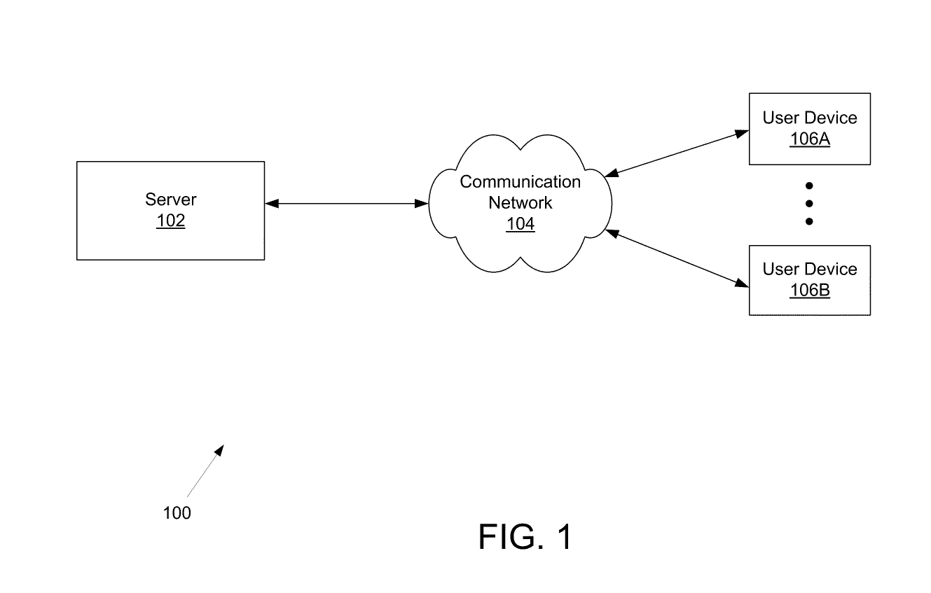

FIG. 1 illustrates an exemplary environment 100 in which embodiments of the present invention may be implemented. In exemplary embodiments, a server 102 is coupled via communication network 104 to a plurality of user devices 106A-106B. The communication network 104 may comprise the Internet, wide area network, and/or a local area network. Certain security protocols (e.g. SSL or VPN) or encryption methodologies may be used to ensure security of data exchanges over communication network 104.

In exemplary embodiments, the server 102 is configured to provide video clips for use in generating a composite video clip. Server 102 may also allow for generation of a composite video clip based on a selected video clip and a recording of a user performance. The composite clip allows for the user performance to appear in context of the selected video clip. Server 102 may be any computing device as is known in the art, including standard computing components such as network and media interfaces, computer-readable storage (memory), and processors for executing instructions that may be stored in memory.

Server 102 may be linked to a video clip library containing various video clips. Server 102 may also provide a mechanism for a user to view, select, and/or obtain one or more video clips for use in generating an composite video clip. In some embodiments, a video clip may require payment of a fee, which may also be process by server 102 or by an auxiliary device in communication with server 102. Additionally, the user may be provided a mechanism for rehearsing with the selected video clip prior to recording the user in a portion of the video clip. Once the user portion is recorded, the server 102 may produce the composite video clip by merging or compositing a recording of the user into the video clip.

In an alternative embodiment, some of the functionalities of the server 102 may be provided to a user device 106A, for example, via a downloadable application or applet. An applet may be downloaded from the server 102 to the user device 106A over communication network 104. Such an applet may allow a user to play a selected video clip on a computing device associated with the user, as well as record the user performance to be merged or composited into the selected video clip. In some embodiments, the applet may also include security measures to limit the play of the video clip to the computing device(s) associated with the user.

The user devices 106A-106B may be associated with one or more users interested in generating a composite video clip. The user devices 106A-106B may include any type of device that has access to the communication network 104. User devices 106A-106B may be any computing device as is known in the art, including standard computing components such as network and media interfaces, computer-readable storage (memory), and processors for executing instructions that may be stored in memory. User devices 106A-106B may comprise, for example, a computing device, laptop or desktop computer, cellular telephone, personal digital assistant (PDA), MP3 player, or any other computing or digital device.

It should be noted that FIG. 1 illustrates one exemplary embodiment of the environment 100. Alternative embodiments may comprise any number of user devices 106A-106B coupled to any type of communications network 104. Additionally, more than one server 102 may be present. For example, back-up or redundancy servers, or servers tasked with particular responsibilities, including but not limited to Digital Rights Management (DRM), advertising or payment processing, may also be present.

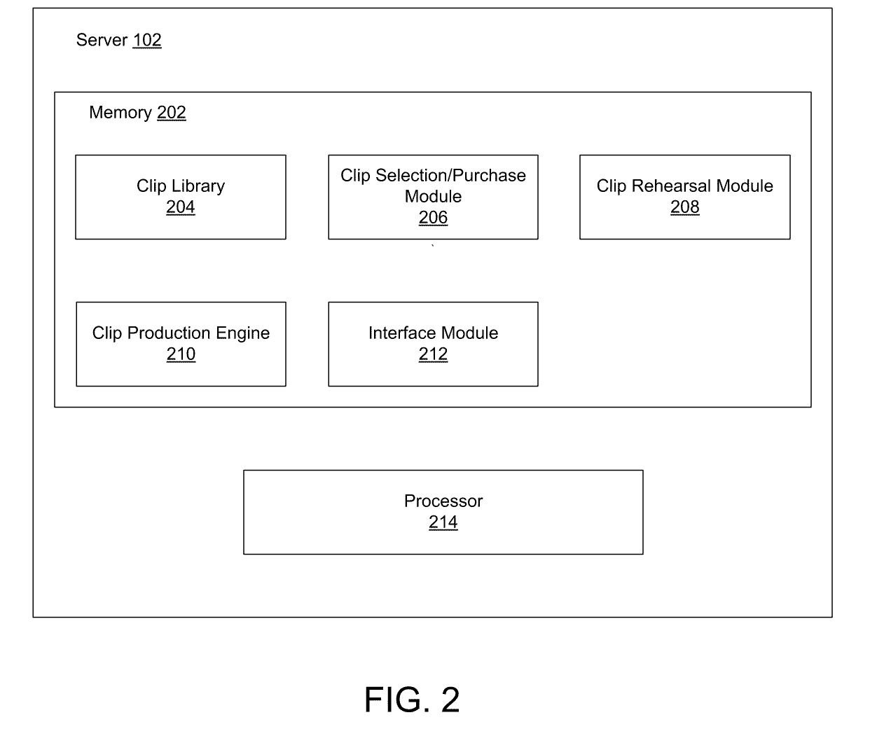

FIG. 2 illustrates an exemplary server 102 for generating a composite video clip. Server 102 may comprise a memory 202, which may include a clip library 204, clip selection/purchase module 206, clip rehearsal module 208, clip production engine 210, and an interface module 212. The clip selection/purchase module 206, clip rehearsal module 208, clip production engine 210, and an interface module 212 may be executable by a processor 214.

Memory 202 is any memory configured to store data. Some examples of the memory 202 are storage devices, such as RAM or ROM. Memory 202 may store various databases, including a clip library 204, and may be housed with the server 102 or in a separate device.

Clip library 204 is a database for storing various media clips. The media clips may include audio and video clips. Such media clips may be provided from various sources, including authors/creators of such media clips, users of the system, partners, associates, etc. In some embodiments, the clip library 204 may be indexed according to type of clip, type of performance, size, content, and various categories.

Clip selection/purchase module 206 may be executable to handle transactions regarding selection and transfer of a video clip to a user. A module (or application), as referenced in the present invention, should be generally understood as a collection of routines that perform various system-level functions and may be dynamically loaded and unloaded by hardware and device drivers as required. The modular software components described herein may also be incorporated as part of a larger software platform or integrated as part of an application specific component.

In particular, clip selection/purchase module 206 may allow for browsing and/or selection from a menu based on the clips available in clip library 204. Samples of the script or of the actual video clips may be provided for confirmation regarding the content of the video clip. The user may then select a video clip from the menu. Alternatively, the user may search for a particular video or particular type of video. For example, a casting call director may request or refer to a particular video clip or type of video clip to express the need for a particular type of performance. The user may search for the video clip by an identifier or using various other search parameters. In some implementations, a fee may be required to access and play certain video clips. Clip selection/purchase module 206 may further be configured to securely process such transactions.

Once the user selects (and, if required, pays for) a video clip, the user is allowed access to the video clip. In one embodiment, the video clip remains stored at server 102 and accessed via a media player on the internet. Clip rehearsal module 208 allows for a user to play the video clip for rehearsal purposes. Toward this end, the clip rehearsal module 208 may present the video clip with a script in the form of subtitles or captions. The user may therefore play the video clip and perform the lines along with the performance in the video clip. In some embodiments, the video clip may be downloaded to a user device. Clip rehearsal module 208 may process the video clip to include subtitles/captions or provide an applet that inserts the subtitles/captions.

Clip production engine 210 merges a user recording with the selected video clip, such that a user performance replaces a recorded performance in the context of the video clip. For example, a video clip of a stage performance of Romeo and Juliet may be composited with a recording of a user who wishes to perform the part of Romeo. As such, the Romeo of the original media clip may be replaced, in part or wholly, by the user. Compositing may include using various techniques, such as facial recognition, automatic scaling, pixel blending, and/or any other equivalent processes to create the composited video clip. The compilation, for example, may comprise detecting the location of a user's eyes, noise, and mouth. A portion of the recorded image (e.g., of the face of the user) of the recording is then composited into the editable version frame by frame (e.g., the recorded image of the user's face is merged over a face on the original video clip) to generate a composited video clip. Some aspects of compositing may be done automatically, and some aspects may be done based on user input.

Server 102 further comprises interface module 212 configured to send and receive information, such as video clips, pre-engineered video clips, composited recordings, messages, alerts, e-mails, casting calls, to and/or from a user of the interactive entertainment system. For example, interface module 212 may receive a user selection of a video clip from the clip library, send a user a pre-engineered version of the video clip designated by the user selection, and receive a recording of a user performance associated with a selected video clip. Interface module 212 may also operate in conjunction with other modules to process transactions, provide access to media clips, and allow for user editing of the composite video clip.

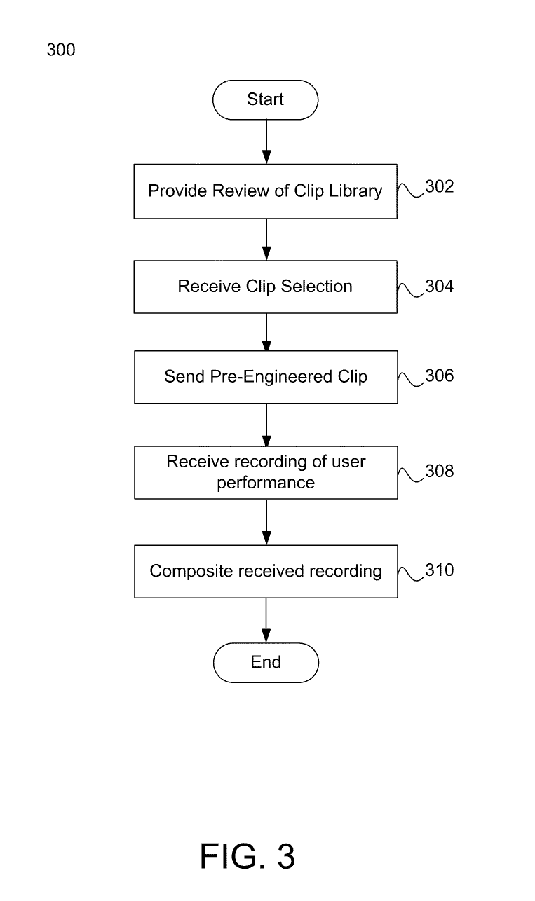

FIG. 3 is a flowchart illustrating an exemplary method 300 for generating a composite video clip. The elements of FIG. 3 are exemplary and may include various alternatives, equivalents, or derviations thereof. Alternative embodiments may comprise more, less, or other steps and still be within the scope of the present embodiment. Additionally, steps may be practiced in a different order.

In step 302, server 102 maintains a video clip library in memory 202, specifically clip library 204. The clip library 204 comprises a plurality of video clips available for selection by a user. A user may be provided with a list or menu of clips from the clip library 204.

In step 304, a user selection of a video clip is received. In some embodiments, the user may be registered with the server 102. Registration may facilitate the transaction of providing the video clip to the user, especially if the selected clip requires a fee for access. The required purchase information with respect to the user may already be stored and/or accessible by the server 102. The purchase information may include user contact information and payment information (e.g., credit card number, Pay Pal information, bank information).

In step 306, server 102 may provide the user with access to a pre-engineered version of the selected video clip. A video clip may be pre-engineered or processed for various purposes, including play on a particular user device, securing against play on unauthorized devices, adding subtitles/captions, etc. The pre-engineered video clip and an applet may be further accompanied by an electronic key enabled for user on the user device 106A associated with the user. The electronic key can secure the pre-engineered video clip against play on devices other than the user device 106A.

In some embodiments, the pre-engineered video clip may be a karaoke video clip that includes a script comprising one or more scrolling lines that are provided along a bottom portion of the pre-engineered video clip for the user to read. Such pre-engineering allows for a user to rehearse along with the video clip. Pre-engineering may be provided by an applet accompanying a video clip downloaded from the server 102 to the user device 106A. An applet may facilitate rehearsal with a downloaded video clip by providing and/or inserting subtitles/captions of the script. The user may thus rehearse by reading the lines of scrolling script while watching an original actor in the video clip reciting the same lines. In some instances, a current word in the script may be highlighted to indicate a speed at which the user should be reading the script. When the user is ready, the user may then begin the process of recording a performance for compositing with the original video clip.

In step 308, a recording of a user performance is received. In exemplary embodiments, the user device 106A may comprise a web camera (“web cam”) or any other video capture device. The user may be provided with a template with guidelines or directions for alignment and positioning in the camera view. For example, a user may be provided with a template directing the user to align his/her face with a marker superimposed on a display associated with the camera.

In more complex performances (e.g., incorporating movement, body alignment), further templates and/or directions may be provided. For example, the user may have to move or adjust the facial angle in accordance with the movement of the character in the video clip. For example, if the character in the video clip turns his head to the right in the video clip, the user may also have to turn his head at the same point when rehearsing the video clip. In exemplary embodiments, the recording may be captured by a web cam of the user device 106A and sent to the server 102.

In step 310, a composite video clip is generated. The recording of the user performance received in step 308 is merged with the original selected clip, so that the user performance appears in the proper context of the selected clip. In some embodiments, the user performance may replace the performance of a performer that appears in the original clip. For example, the face and/or body of the user appears in the place of the original performer, and the audio

In some embodiments, server 102 may allow for a user to preview the composite clip and to submit a substitute recording for compositing if the user do not approve of a composite clip based on a first recording. If the user, however, approves of the composite clip, the composited video clip may be made available to the user for downloading, linking, emailing, quality adjustments, etc. For example, a user may adjust the video clip in terms of rotation or other slight positional adjustments of the composited video clip. Adjustments may also include altering color, brightness, contrast, or other image adjustments. The composite video clip may be adjusted manually by the user or automatically by the server 102. In some embodiments, an applet allows for receipt of user feedback regarding adjustment of the composite video clip.

Following any necessary or desired adjustments by the user, the composite video clip is finalized. In one embodiment, the composite video clip may be stored at the server 102 or another database accessible to the user. The composite video clip may also be displayed and shared with other users. The composite video clip may also be exported to other systems for further editing, hosting, display, and/or sharing. In some embodiments, the composite video clip may be e-mailed to the user or distributed to others designated by the user. For example, a composite video clip may be used in the context of a casting call and submitted to a contact listed in the casting call.

It should be noted that an applet may be downloaded onto the user device 106A for performing some of the functions described above corresponding to the modules of server 102, including clip selection/purchase module 206, clip rehearsal module 208, and/or clip production engine 210. For example, the applet may allow for the rehearsal of the pre-engineered video clip, recording of the performance, and adjustments to the composited recording. Alternatively, the rehearsal, recording, and adjustment may occur while the selected video clip is hosted on the server 102.

With the present invention, a casting call can be managed by the server 102 with some of the typical steps of a casting call to be partially automated. In one embodiment, a casting call may refer to a type of performer who may appear in one or more video clips available from server 102. The casting call may further refer specifically to a particular scene in a particular video clip by title, clip identifier, etc. Performers interested in responding to the casting call may review the video clip to determine the requirements of the casting call and further, to audition via a composite video clip.

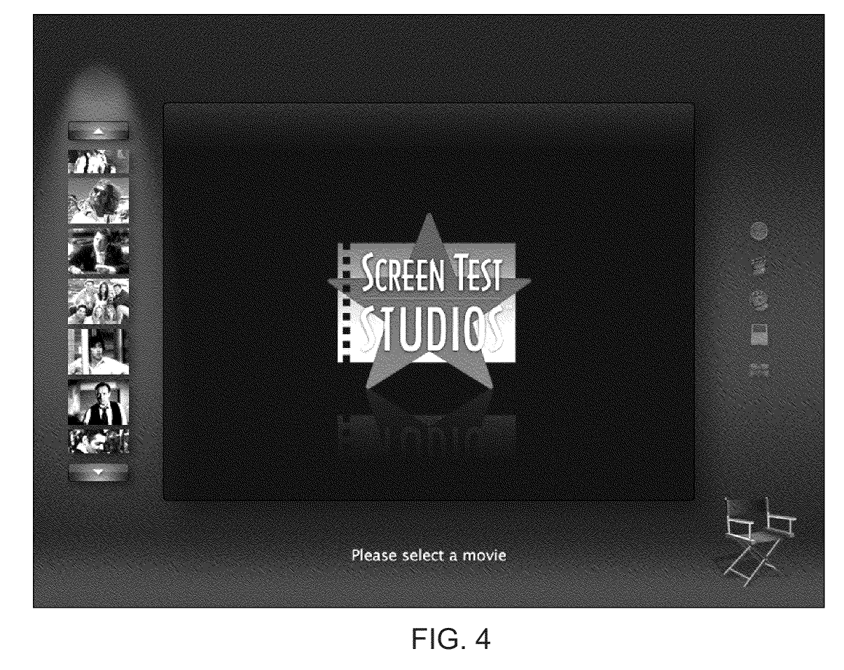

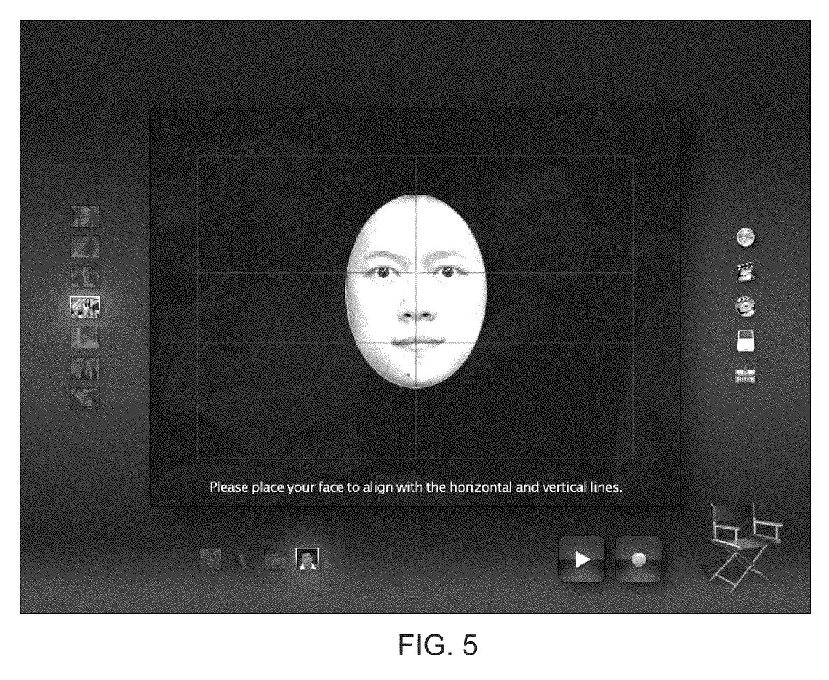

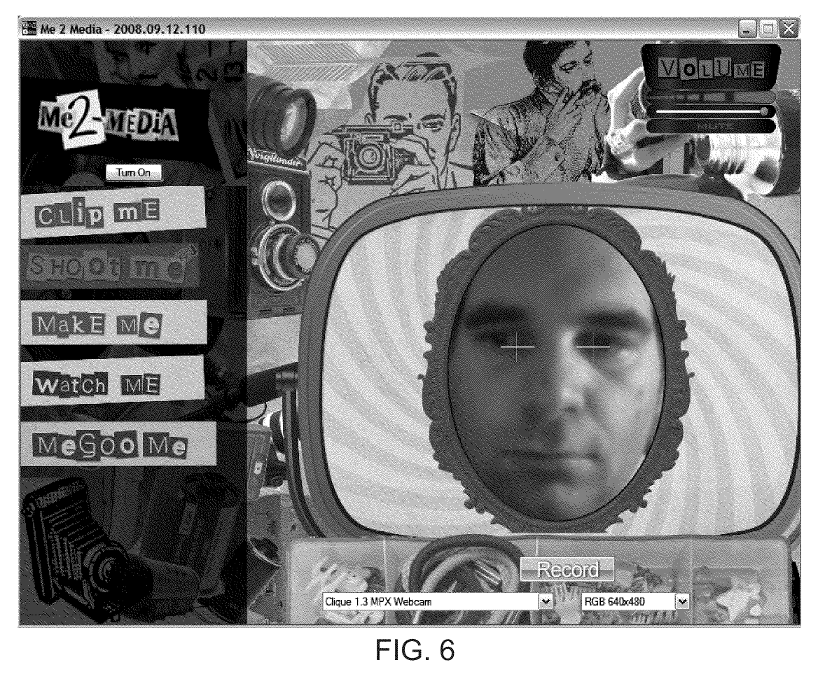

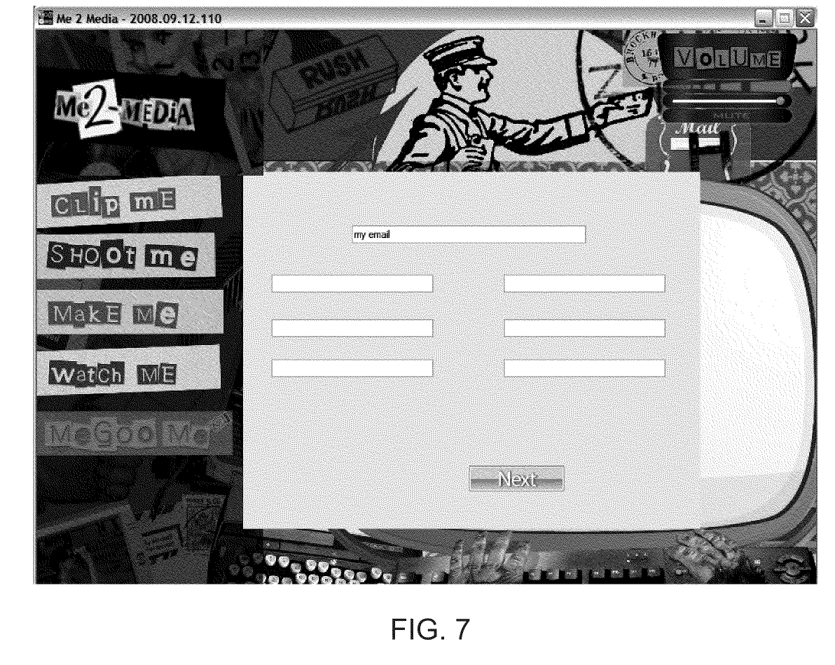

Various screenshots are provided to illustrate exemplary implementations of the present invention. FIG. 4 is a screenshot of an exemplary interface for browsing a clip library 204. FIG. 5 is a screenshot of an exemplary template used to align a user's image. FIG. 6 is a screenshot of an exemplary adjustment screen. FIG. 7 is a screenshot of an exemplary interface for exporting the composite video clip.

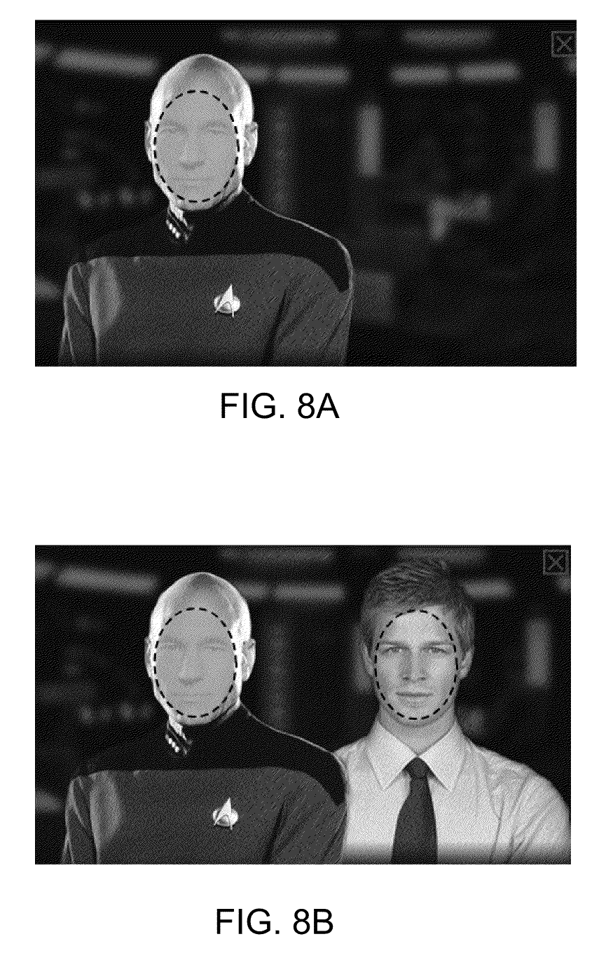

FIG. 8A is a screenshot of an exemplary pre-engineered video clips. In FIG. 8A, the performer present in the video clip is illustrated with a masking designation on his face. The portion of the face to be masked is designated by the hashed line. During normal play of the video clip provided to the user, the performer may not appear masked. The information provided with video clip, however, will indicate that the face of the performer is designated for masking.

FIG. 8B is a screenshot of an exemplary implementation of an interactive entertainment system for recording performance. FIG. 3B illustrates that an image of a user is designated for insertion into a corresponding portion of the video clip. In this instance, the face of the user is designated (e.g., by hashed lines) to replace the face of the performer present in the video clip.

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for generating a composited video clip, the method comprising:
maintaining a clip library in memory, the clip library comprising a plurality of video clips;
receiving a selection from a user, the selection designating a video clip from the clip library;
sending the user a pre-engineered version of the video clip designated by the user selection, the pre-engineered video clip configured for play on a user device associated with the user;
receiving a recording, wherein the recording captures a user performance associated with the selected video clip; and
executing instructions stored in memory, wherein execution of the instructions by a processor generates a composite video clip based on the video clip designated by the user selection and the received recording, the generated composite video clip including the user performance in context of the selected video clip.

2. The method of claim 1, wherein the pre-engineered video clip includes a visual display of one or more lines from a script associated with the video clip.

3. The method of claim 1, wherein the pre-engineered video clip includes an applet that allows for the pre-engineered video clip to be played on the user device associated with the user.

4. The method of claim 3, wherein the applet further includes an electronic key configured to secure the pre-engineered video clip against play on devices other than the user device.

5. The method of claim 3, wherein the applet includes a template, the template including alignment information for recording an image.

6. The method of claim 3, wherein the applet is configured to receive user feedback regarding adjustment of the composited video clip.

7. The method of claim 1, wherein the recording includes audio of the user performance.

8. The method of claim 1, further including saving the generated composited video clip to a database in memory.

9. The method of claim 1, further including adjusting the composited video clip.

10. A method of claim 1, further comprising submitting the composited video clip to a designated recipient.

11. A system for generating a composited video clip, the system comprising:
a memory configured to maintain a clip library comprising a plurality of video clips;
an interface configured to
receive a user selection of a video clip from the clip library,
send the user a pre-engineered version of the video clip designated by the user selection, the pre-engineered video clip configured for play on a user device associated with the user, and
receive a recording, wherein the recording captures a user performance associated with the selected video clip; and
a processor configured to execute instructions stored in memory, wherein execution of the instructions by a processor generates a composite video clip based on the video clip designated by the user selection and the received recording, the generated composite video clip including the user performance in context of the selected video clip.

12. The system of claim 11, wherein the pre-engineered video clip includes a visual display of one or more lines from a script associated with the video clip.

13. The system of claim 11, wherein the processor is further configured to generate an applet executable by the user device to allow for the pre-engineered video clip to be played on the user device associated with the user.

14. The system of claim 13, wherein the applet further includes an electronic key configured to secure the pre-engineered video clip against play on devices other than the user device.

15. A computer-readable storage medium, having embodied thereon a program, the program being executable by a processor to perform a method for generating a composited video clip, the method comprising:
maintaining a clip library comprising a plurality of video clips;
receiving a user selection of a video clip from the clip library;
sending the user a pre-engineered version of the video clip designated by the user selection, the pre-engineered video clip configured for play on a user device associated with the user;
receiving a recording, wherein the recording captures a user performance associated with the selected video clip; and
compositing the received recording with the selected video clip to generate a composited video clip in which the user performance appears in context of the selected video clip.

16. The computer-readable storage medium of claim 15 wherein the pre-engineered version includes a visual display of a script associated with the video clip.

17. The computer-readable storage medium of claim 15, the method further including adjusting the composited video clip.

18. The computer-readable storage medium of claim 15, the method further including receiving user feedback regarding adjustment of the composited video clip.

19. The computer-readable storage medium of claim 15, the method further including saving the generated composited video clip to a database in memory.

20. The computer-readable storage medium of claim 15, the method further including submitting the composited video clip to a designated recipient.
